(19) United States
(12) Patent Application Publication
(10) Pub. No.: US 2005/0179930 A1
(43) Pub. Date: Aug. 18, 2005

(54) Image forming apparatus, image forming system, and image forming method, program and recording medium

(75) Inventors: Takahiro Doi, Toyokawa-shi (JP); Masazumi Ito, Toyohashi-shi (JP)

Correspondence Address: BURNS DOANE SWECKER & MATHIS L L P, POST OFFICE BOX 1404, ALEXANDRIA, VA, 22313-1404, US

(73) Assignee: Konica Minolta Business Technologies, Inc., Chiyoda-ku (JP)

(21) Appl. No.: 10/816,823

(22) Filed: Apr. 5, 2004

(30) Foreign Application Priority Data
Feb. 13, 2004 (JP) 2004-037232

(51) Int. Cl. G06F 1/32; H04N 1/00; G06F 3/12; G06F 15/00

(52) U.S. Cl. 358/1.14; 713/320; 358/400; 358/402; 358/1.15; 708/206

(57) ABSTRACT

Provided is an image forming apparatus that has a power-saving control unit controlling a power-saving mode to be activated or deactivated, and that transmits and receives data to/from an external apparatus. The image forming apparatus includes: a communication unit that accesses the external apparatus, and, when the external apparatus stores image data addressed to the image forming apparatus, obtains the image data; an image forming unit that forms an image according to the obtained image data; and a communication control unit that controls the communication unit to access the external apparatus while the power-saving mode is deactivated, for example i) when the power-saving mode gets deactivated, and ii) when an image forming operation ends.

This application is based on application No. 2004-37232 filed in Japan, the content of which is hereby incorporated by reference.

### BACKGROUND OF THE INVENTION

(1) Field of the Invention

The present invention relates to an image forming apparatus that has a power-saving function, in addition to a function of forming images according to the data obtained from an external apparatus. The present invention also relates to an image forming system that includes such an image forming apparatus. The present invention further relates to an image forming method and a program executed in the image forming apparatus, and to a computer-readable recording medium recording the program therein.

(2) Description of Related Art

Recently, multiple image forming apparatuses have been commercialized that enable transmission/reception of data to/from a server and other external devices, via a network, in addition to functioning as a copier and a printer. Hereinafter, such a multiple image forming apparatus is referred to as “MFP (multi-function peripheral)”.

Recently, MFPs even equipped with an internet facsimile function have appeared. Here, the internet facsimile (hereinafter abbreviated as “i-FAX”) is defined in the RFC (request for comments) 2305, the RFC2532, and the like, and performs transmission/reception of image data for conventional facsimiles as an attachment file of electronic mail, after converting such image data (hereinafter “normal FAX data”) into TIFF (tag image file format) data.

Unlike the transmission/reception of normal FAX data using the general telephone circuit, the transmission/reception of data using this internet facsimile will not be charged according to the communication distance, and so is rapidly prevailing as the means to transmit/receive the image data for great distances, in particular.

A conventional MFP having such i-FAX function is structured to access the mail server at a predetermined time interval (e.g. 60 minutes), and download data for i-FAX destined for the mail address of the MFP itself, if any. Hereinafter, such data addressed to i-FAX is referred to as i-FAX data. Then, the MFP decodes the normal attachment FAX data into original image data, and outputs the original image data to paper.

Incidentally, with an MFP, particularly with an MFP whose image forming unit (a print engine) adopts an electrophotographic method, it is necessary to maintain the temperature of the fixing roller of the fixing device to be high (e.g. 150° C.), so as to fix the toner image transferred to the paper. Therefore, such MFPs consume a large amount of power. In view of saving power, most of MFPs have a mode for saving consumption power. In the mode, when an image forming operation (hereinafter “print operation”) is not performed for a predetermined time period, the temperature of the fixing device is decreased or the power supply to the fixing device is completely turned off, and sometimes the power supply is turned off even to the circuits that do not relate to communication and power-saving control (hereinafter, the mode being referred to as “power-saving mode”). The power-saving mode is to be maintained until such an event as receiving a print job and receiving operation directed to the operation panel.

However, a conventional MFP is designed to access the mail server regularly when a planned time arrives, even during the power-saving mode. When i-FAX data addressed to the MFP itself exists in the mail server, the MFP downloads the i-FAX data, and deactivates the power-saving mode to perform a print operation according to the image data within the i-FAX data. This is problematic because enough energy-saving is not realized.

### SUMMARY OF THE INVENTION

In view of the aforementioned problems, the object of the present invention is to prevent decrease in power-saving effect as much as possible, in an image forming apparatus that activates power-saving control under a given condition, and obtains data addressed to the image forming apparatus itself by accessing an external apparatus such as a mail server, for forming an image.

The above object is achieved by an image forming apparatus for transmitting and receiving data to/from an external apparatus, the image forming apparatus having: a communication unit that accesses the external apparatus, and when the external apparatus stores image data addressed to the image forming apparatus, obtains the image data; an image forming unit that performs an image forming operation according to the obtained image data; a power-saving control unit that controls a power-saving mode to be activated or deactivated; and a communication control unit that controls the communication unit to make an access to the external apparatus while the power-saving mode is deactivated.

With the above structure, the communication is made to always access the external apparatus, while the power-saving mode for the image forming apparatus is not activated. Therefore even when the external apparatus is accessed next time while the power-saving mode is activated thereafter, there is little probability that the external apparatus stores image data addressed to the image forming apparatus at this time. This can accordingly decrease occurrence of a case where the power-saving mode is interrupted to decrease the power-saving effect.

Here, “image data” means not only image data resulting from bit-map expansion, but also includes wide varieties of image data, such as image data resulting from compression by a predetermined method, and image data resulting from conversion into a predetermined format.

Here, the access may be made when the power-saving mode gets deactivated, or may be made when an image forming operation ends.

Moreover, the communication control unit may further control the communication unit to make another access to the external apparatus when a first time period has passed after a last access to the external apparatus. According to these structures, the communication unit assuredly accesses the external apparatus at least in every first time period, for checking existence of image data addressed to the image forming apparatus.

In addition, the image forming apparatus may further have a prohibition unit that prohibits the communication unit from accessing the external apparatus, until a second time period has passed after a last access to the external apparatus.

According to this structure, the communication unit is refrained from accessing the external apparatus too frequently, thereby reducing unnecessary burden on the communication network.

In addition, the above object is also achieved by an image forming system having: a server for storing image data; and an image forming apparatus for transmitting and receiving data to/from the server via a network, where the server includes: a storage unit that stores image data in correspondence with a network address; and a transmission unit that, in response to a request by an external terminal, transmits image data that corresponds to a network address of the external terminal, and where the image forming apparatus includes: a request unit that accesses the server and requests, from the server, image data addressed to the image forming apparatus; a reception unit that receives the image data transmitted from the server; an image forming unit that performs an image forming operation according to the received image data; a power-saving control unit that controls a power-saving mode to be activated or deactivated; and a request control unit that controls the request unit to access the server while the power-saving mode is deactivated.

Furthermore, the above object is also achieved by an image forming method executed in an image forming apparatus, the image forming apparatus having a power-saving unit that controls a power-saving mode to be activated or deactivated, and being for transmitting and receiving data to/from an external apparatus, the image forming method having: an image-data obtaining step of making an access to the external apparatus while the power-saving mode is deactivated, and of, when the external apparatus stores image data addressed to the image forming apparatus, obtaining the image data; and an image forming step of performing an image forming operation according to the obtained image data.

Furthermore, these image forming methods may be programmed so as to be executed by an image forming apparatus.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1. is a block diagram showing one example of the structure of an image forming apparatus (MFP) that relates to the embodiments of the present invention, and of a network system that includes this MFP;

FIG. 2 is a block diagram showing the structure of a control unit within the MFP;

FIG. 3 is a flowchart showing the content of i-FAX data receiving operation that is performed in an MFP of the first embodiment;

FIG. 4 is a flowchart showing the content of i-FAX data transmission/reception operations that are performed in the server of the first embodiment;

FIG. 5 is a diagram showing one example of the time chart for the i-FAX data receiving operation, together with the communication sequence with other devices, in the first embodiment;

FIG. 6 is a flowchart showing the content of i-FAX data receiving operation that is performed in an MFP of the second embodiment; and

FIG. 7 is a diagram showing one example of the time chart for the i-FAX data receiving operation, together with the communication sequence with other devices, in the second embodiment.

### DESCRIPTION OF THE PREFERRED EMBODIMENTS

The following describes embodiments of image forming apparatuses that relate to the present invention, with reference to the drawings.

### First Embodiment

(1) Structure of Image Forming Apparatus and Network System

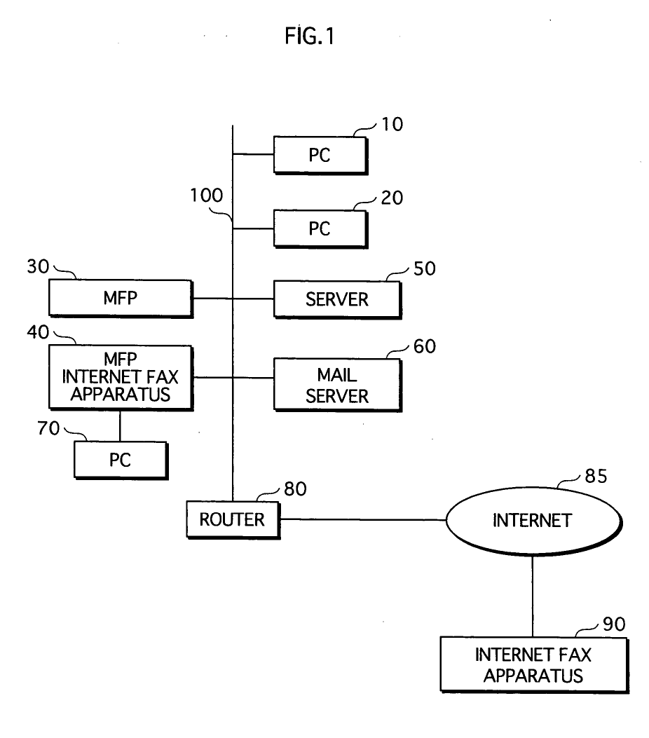

FIG. 1 is a functional block diagram that shows one example of the structure of the network system that includes the image forming apparatus (MFP) that relates to the first embodiment of the present invention.

In the present network system, personal computers (PC) 10 and 20 (being terminal apparatuses), MFPs 30 and 40, a server 50 such as a file server, and a mail server 60 are connected to a LAN (local area network) 100.

Further to the LAN 100, an internet FAX apparatus 90 is connected, via a router 80 and an internet 85, so as to constitute an IP (internet protocol) network as a whole.

In the present embodiment, the MFP40 has an i-FAX function, and the mail server 60 is structured by installing an electronic mail server program into a computer which comprises a CPU, a memory, and a storage apparatus such as a hard disk drive and so on.

Furthermore, a PC70 is serial-connected to the MFP40, and data can be transmitted and received between them.

In the network system, i-FAX data transmitted from the internet FAX apparatus 90 is stored in the storage apparatus of the mail server 60, in association with the destination electronic mail address (hereinafter “electronic mail address” being simply referred to as “mail address”).

On the other hand, the MFP40 accesses the mail server 60 at a timing that does not reduce the power-saving effect as possible, and checks if the mail server 60 stores i-FAX data destined for the mail address assigned to the MFP40 itself. When there is such i-FAX data, the MFP40 downloads the data, and forms an image on recording sheets such as transfer paper, according to the image data of the attachment file of the downloaded data. In view of this, the present network system can also be interpreted as an image forming system.

Transmission/reception of i-FAX data to/from the mail server is, as aforementioned, executed in accordance with the publicly-known communication protocol defined such as in the RFC2305 and RFC2532.

It should be noted here that, in the network system of FIG. 1, the mail server 60 is directly connected to the LAN100. However, a mail server may be placed outside the LAN100, and be used via the internet. In addition, the external internet FAX apparatus is not limited to an apparatus dedicated to i-FAX, and may alternatively be an i-FAX function-equipped MFP, just as the MFP40, or may be a PC in which an i-FAX program is installed. Moreover, there is no particular limitation on the number of i-FAX function-equipped apparatuses. That is, the present invention is applicable to a system in which two or more i-FAX function-equipped apparatuses are connected via a network, and data transmission/reception is performed therebetween, via a mail server.

(2) Structure of Control Unit 400 within MFP40

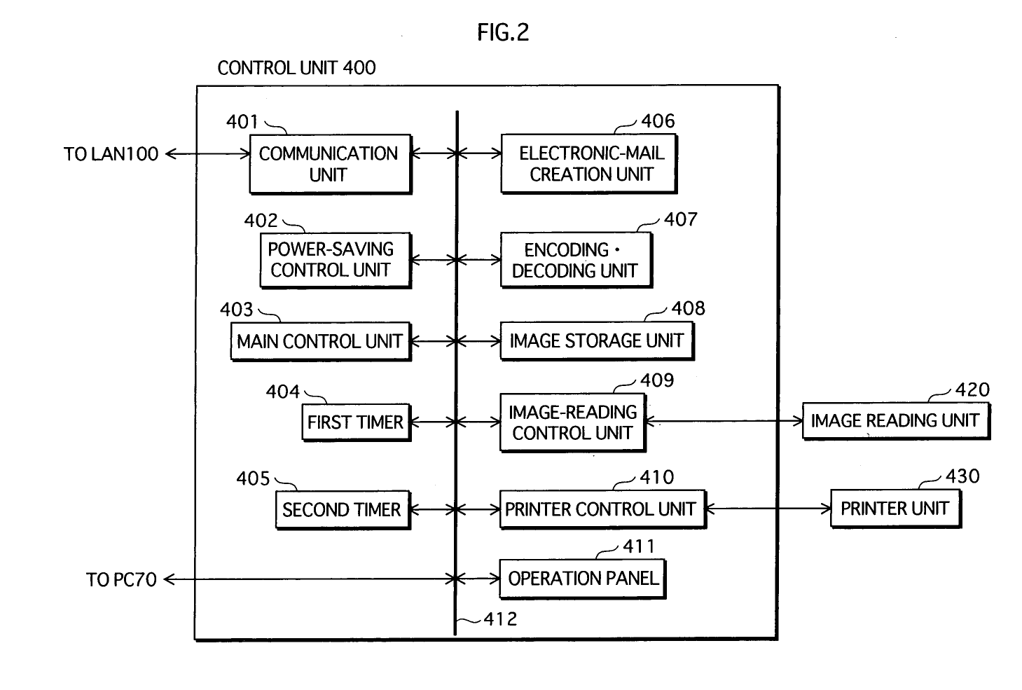

FIG. 2 is a functional block diagram showing the structure of a control unit 400 within the above-described MFP40.

As FIG. 2 shows, the control unit 400 is structured by connecting, via a bus 412, such as a communication unit 401, a power-saving control unit 402, a main control unit 403, a first timer 404, a second timer 405, an electronic-mail creation unit 406, an encoding/decoding unit 407, an image storage unit 408, an image-reading control unit 409, a printer control unit 410, and an operation panel 411.

The communication unit 401 communicates with an external device, via a network, such as the LAN 100. A concrete example of the communication unit 401 is a network IF (interface) card.

The power-saving control unit 402, referring to a time counted by the second timer 405, performs control to activate the power-saving mode if no print operation is performed for a predetermined time period (third time period: 20 minutes for example). The power-saving control unit 402 deactivates the power-saving mode when an event occurs that necessitates a print operation, for example when the main control unit 403 issues a print request to the printer control unit 410, and when a copy-operation instruction is received from the operation panel 411.

It should be noted here that in the first embodiment, a publicly-known electrophotographic type image forming apparatus is used as the printer unit 430. Therefore the control performed in the power-saving mode is mainly either to lower the temperature of the fixing heater at the fixing device of the printer unit 430, or to turn the power off to the fixing device. However, other parts of the MFP40 may be additionally controlled to consume less power, such as by shutting off the backlight of the liquid crystal display of the operation panel 411.

The main control unit 403 expands the image data to the image storage unit 408, and controls the communication unit 401 to access the mail server 60 at a predetermined timing, and gives instructions to such as the image-reading control unit 409 and the printer control unit 410, so that image-reading operations and print operations are performed smoothly.

The first timer 404 is reset every time the communication unit 401 accesses the mail server, and counts the time passed after the last access.

The second timer 405 counts the time passed after a print operation has ended, and resets the counted time when the power-saving mode gets activated.

The electronic-mail creation unit 406 attaches image data in TIFF format to electronic mail, to create i-FAX data. The encoding/decoding unit 407 generates normal FAX data (publicly known) by encoding the image data, and extracts normal FAX data from received i-FAX data, and decodes the normal FAX data.

The image storage unit 408 is to store image data. Image data to be stored here includes data that results by expanding print data transmitted from such as an external computer, and image data that results by the image reading unit 420 reading an original image.

The image-reading control unit 409 controls the image reading unit 420 to read an original image. The printer control unit 410 controls the printer unit 430 to perform a print operation for forming an image on paper.

When i-FAX is transmitted from such an MFP40, a user sets an original to the image reading unit 420, operates the operation panel 411 to switch to an i-FAX mode, inputs the destination mail address, and pushes the start button (not shown in the drawings).

The image data, resulting by the image-reading unit 420 reading the original, is compressed at the encoding/decoding unit 407, by such compression methods as MH, MR, and MMR, then the compressed image data is converted into a TIFF file by another unit such as the main control unit 403. At the electronic-mail creation unit 406, this TIFF file is attached to the electronic mail destined for the destination mail address, and is transmitted from the communication unit 401, as i-FAX data.

On the contrary, when receiving i-FAX data, the communication unit 401 accesses the mail server 60. When the storage apparatus of the mail server 60 stores i-FAX data destined for the mail address of the MFP, the communication unit 401 receives the data.

Note that in the present embodiment, after obtaining i-FAX data that the mail server 60 has received, the communication unit 401 transmits a “dele” command to the mail server 60, so as to delete the received i-FAX data from the mail server 60, thereby reducing burden born by the server. However, a structure is also possible in which the mail server 60 accumulates all the i-FAX data received so far, and the communication unit 401 down loads only new i-FAX addressed to the MFP40 when accessing the mail server 40.

The data in the attachment file of the i-FAX data is converted to normal FAX data from TIFF file, for example at the mail control unit 403, then is decoded at the encoding/decoding unit 407, and is temporarily stored in the image storage unit 408, as image data to be subjected to a print operation.

The main control unit 403 issues a print request, for making the printer unit 403 read the image data from the image storage unit 408 and form an image according to the image data. The printer unit 430, in response to this print request, performs a print operation.

Note that to the bus 412, an external PC70 is connected via a serial interface such as RS-232C (not shown in the drawings) This PC70 not only issues a print job to the MFP40, but also is operable to perform the same kinds of settings as performed by the operation panel 411, such as a print condition for each type, a time interval for determining the timing of normal access (60 minutes in the aforementioned example), and a time setting for a wait time until the power-saving mode is activated.

(3) Content of i-FAX Data Reception Control that Control Unit 400 Performs

As described above, the image forming apparatus relating to the present invention is characterized that it obtains i-FAX data and forms an image, at a timing that does not decrease the power-saving effect as possible. In view of this, the following details the control performed at the main control unit 403 when the MFP40 receives i-FAX data from the mail server 60.

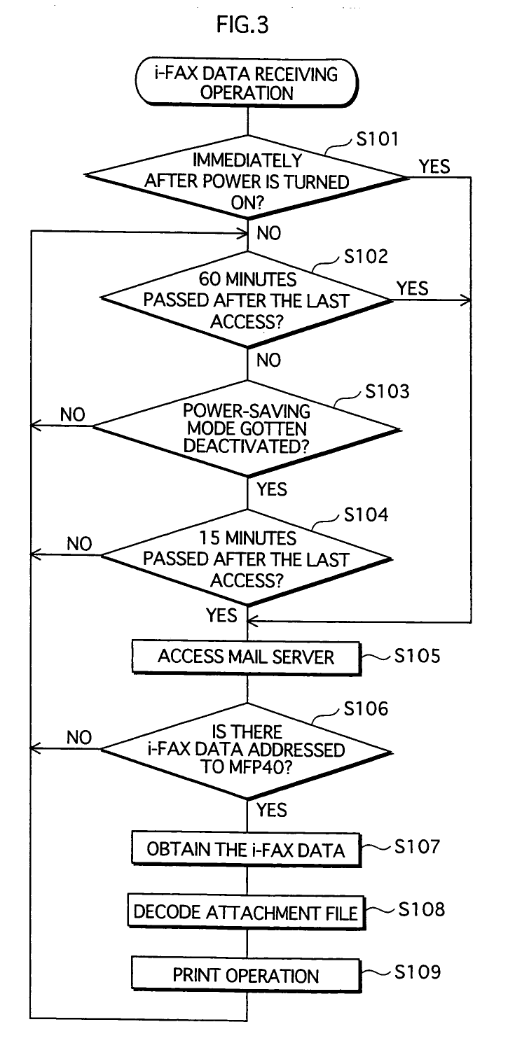

FIG. 3 is a flowchart for explaining the operation content in a case where the MFP40 receives i-FAX data by accessing the mail server 60.

First, the main control unit 403 judges whether it is immediately after the power is turned on to the MFP40 (e.g. within 1 minute) (Step S101), and when judging affirmatively, goes to Step S105, and sends an instruction to the communication unit 401 to access the mail server 60.

When, at Step S101, it is judged not immediately after the power turned on, the main control unit 403 goes to Step S102, and judges whether a first time period (60 minutes in this embodiment) has passed after the last access to the mail server 60.

As mentioned above, every time the communication unit 401 accesses the mail server 60, the first timer 404 resets the counted time to restart counting. The main control unit 403 refers to the time counted by this first timer 404, for performing the aforementioned judgment.

When the counted time has passed 60 minutes, then the main control unit 403 goes to Step S105, and sends an instruction to the communication unit 401 to access the mail server 60.

On the contrary, when it is judged negatively at Step S102, judgment is performed, at Step S103, as to whether the power-saving mode has gotten deactivated.

When one of the predetermined events has occurred during the power-saving mode, the power-saving mode gets deactivated, and a flag representing the deactivating of the power-saving mode is stored in the memory with in the power-saving control unit 402, to which the main control unit 403 can refer in performing judgment of Step S103. Note that in the present embodiment, this flag is reset if judged “YES” at Step S104, for example.

At Step S103, if judgment is made that it is when the power-saving mode has gotten deactivated, then a judgment is performed as to whether a second time period (15 minutes in the present embodiment) has passed after the last access to the mail server 60, by referring to the first timer 404 (Step S104). If 15 minutes has passed, access to the mail server 60 is performed, according to the aforementioned communication protocol (Step S105).

Such a control of access using time limit attempts to reduce unnecessary burden for the network, by prohibiting access within a predetermined time period, because i-FAX electronic mail is not received so often. Therefore, simply from a power-saving point of view, such a time-limit control is not essential. In addition, it is desirable that this time limit (i.e. second time period) is shorter than a wait time until the power-saving mode is performed (i.e. third time period) Otherwise, there is a possibility that next power-saving mode is activated, before not even one access is performed while the power-saving mode is deactivated.

At Step S106, when judgment is made that there is new i-FAX data addressed to the MFP40 itself, the data is received and obtained (Step S107).

The i-FAX data obtained from the mail server 60 is temporarily stored in a nonvolatile memory (not shown in the drawings), then is subjected to MIME inverse-conversion, then encoded image data is extracted after the TIFF file contained in its attachment file is analyzed. The extracted image data is then decoded at the encoding/decoding unit 407 (Step S108), and the printer unit 430 is made to perform a print operation according to the decoded image data (Step S109).

The operations in the aforementioned Steps S102-S109 are repeatedly performed at a predetermined time cycle, unless a main power source of the MFP40 is not turned off.

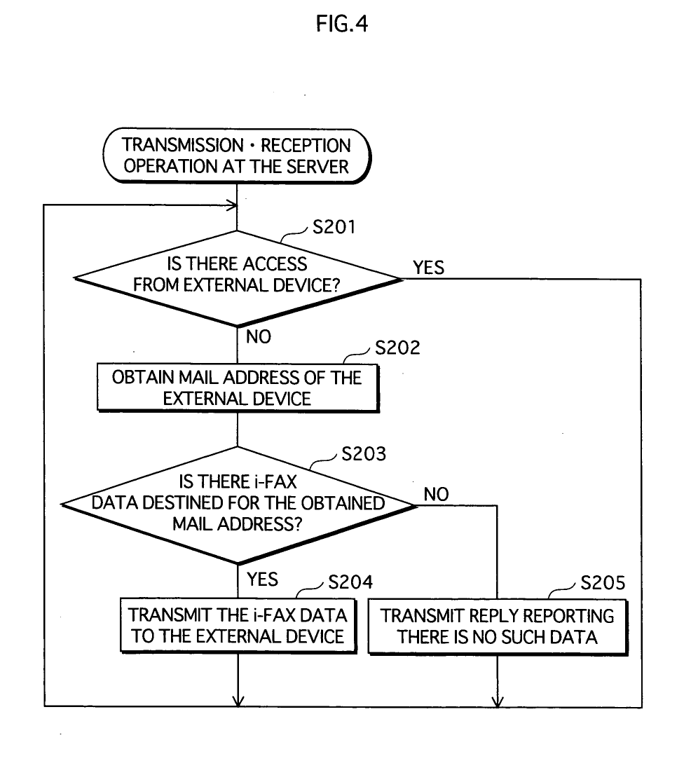

FIG. 4 is a flowchart showing the content of i-FAX transmission/reception operations in case when the mail server 60 has received an access from an external device (such as the MFP40).

Please note that the transmission/reception operations are also performed basically according to the publicly-known communication protocol, therefore only the general information thereof is given below.

The mail server 60, upon receiving an access from an external device, obtains the mail address of the external device (Step S201:YES, S202), and checks if there is new i-FAX data in the mail box for the obtained mail address (Step S203), and when there is such i-FAX data, transmits a reply reporting such to the external device. Then when a transmission request is received from the external device, the mail server 60 transmits the i-FAX data to the external device (Step S204).

When there is no i-FAX data addressed to the external device, a reply reporting that there is no such data is transmitted to the external device (Step S205).

As seen above, the present embodiment is designed to access the mail server 60 when the power-saving mode of the MFP40 gets deactivated. Since the power-saving mode has been already deactivated, even if i-FAX data addressed to the MFP40 is received at this timing, the MFP40 does not need to take the trouble to deactivate the power-saving mode, only for outputting of the i-FAX data.

In addition, by performing access when the power-saving mode gets deactivated, even if a first time period (60 minutes) ends during the power-saving mode and an other access is performed as conventionally, the probability is lessened that the mail server 60 stores i-FAX addressed to the MFP40 at the time of the other access (hereinafter, such an access performed when the first time period has passed is occasionally referred to as “regular access”). This will accordingly lessen the probability of necessitating deactivation of the power-saving mode for the purpose of outputting the i-FAX data, thereby preventing decrease in power-saving effect.

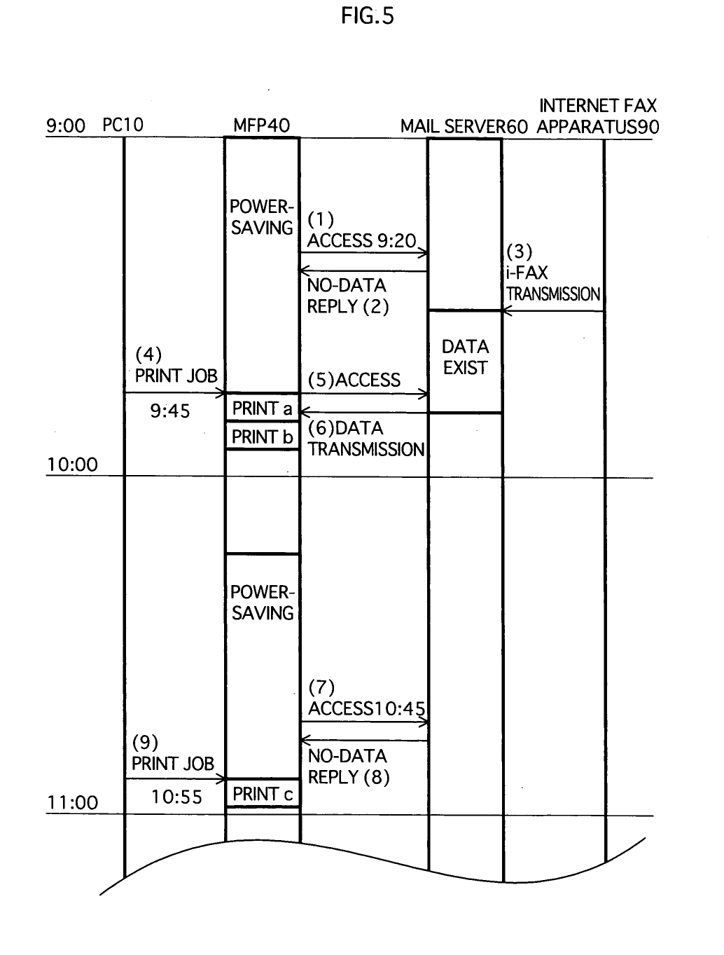

FIG. 5 shows one example of time chart for the i-FAX data receiving operation in the first embodiment, together with the communication sequence with other devices.

As shown in this drawing, at 9:00 AM, the MFP40 is in the power-saving mode. At 9:20, the time has arrived when a regular access to the mail server 60 is to be performed, and so access to the mail server 60 is performed ((1)), however the mail server 60 has not received any i-FAX data addressed to MFP40, therefore a “no-data” reply is transmitted to the MFP40 ((2)). At this stage, there is no data to be printed out, therefore the power-saving mode of the MFP40 will continue without interruption.

After this, i-FAX addressed to the MFP40 is transmitted from the internet FAX apparatus 90 to the mail server 60 ((3)). At the time 9:45, when the MFP40 receives a print job from the PC10 ((4)), the power-saving mode gets deactivated at approximately the same time, and the MFP40 starts the operation for the print job (i.e. print a), and accesses the mail server ((5)).

By this time, the i-FAX data addressed to the MFP40 has received from the internet FAX apparatus 90, therefore the data is downloaded and a print job b is performed according to the downloaded i-FAX data, following the print job a.

When a predetermined third time period (20 minutes) has passed after the print job b ends, the power-saving mode gets activated. At the time 10:45, when 60 minutes has passed after the access of (5), access to the mail server 60 is performed ((7)). Since acquisition of i-FAX data has been already performed at the aforementioned time of (5), there is no new i-FAX data addressed to the MFP40 left, accordingly a “no-data” reply is transmitted from the mail server 60 ((8)). Therefore, the power-saving mode does not get deactivated because there is no need for print operation.

After this, when a print job is received from the PC10, at the time 10:55, the power-saving mode is deactivated to perform the print operation. However, since 15 minutes has not passed after the access of (7), a new access to the mail server 60 is not performed here (refer to FIG. 3, Step S104).

As described above, the present embodiment has a structure of accessing the mail server 60 when the power-saving mode gets deactivated. This structure lessens the probability that the mail server 60 stores new i-FAX data when a timing for a regular access has arrived in the middle of the power-saving mode, thereby preventing the decrease in power-saving effect as much as possible, which would be attributable to an i-FAX data print operation.

More specifically, in the conventional method where only regular access is performed, the access of (5) in FIG. 5 is not performed. Therefore, the next access is to be 60 minutes after the access of (1) which is during the power-saving (around the time 10:20). However, at this time, the mail server 60 stores i-FAX data received at (3), and so a print operation therefor should be performed at this time, by interrupting the power-saving mode. Concretely, the print operation is performed after a period of time (e.g. 5 minutes) of waiting for the temperature of the fixing roller to rise to a predetermined level. After this, if no event occurs for 20 minutes, the power-saving mode will be activated. According to this structure, even if i-FAX data whose original is of only one page, the already activated power-saving mode will be interrupted at least for 25 minutes, significantly decreasing the power-saving effect. On the contrary, the present embodiment lessens the probability of causing such a case, as described above.

### Second Embodiment

Next, the second embodiment of the present invention is described. The first embodiment is structured so that, in the i-FAX data receiving operation performed by the MFP40, access to the mail server 60 is performed when the power-saving mode gets deactivated. The second embodiment is characterized that access is performed when a print operation ends.

Accordingly, the hardware structures and the like of the image forming system and the MFP40, of the second embodiment, are the same as the counterparts of the first embodiment. Therefore the following description mainly focuses on the i-FAX receiving operation.

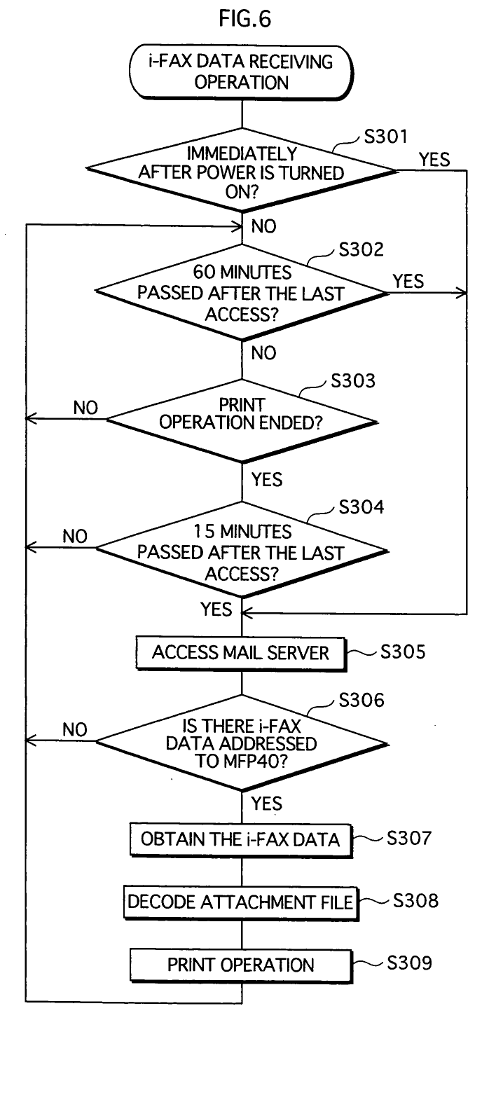

FIG. 6 is a flowchart showing the contents of the i-FAX data receiving operation that is performed by the main control unit 403 of the MFP40 in the second embodiment. The following description does not explain the contents common to the counterparts in FIG. 3.

First, judgment is performed as to whether it is immediately after the power is turned on to the MFP40 (Step S301), if the judgment results in the affirmative, the control goes to Step S305, to give an instruction to the communication unit 401 to access the mail server 60.

At Step S301, if it is judged that it is not immediately after the power is turned on, the control goes to Step S302, and then judgment is performed as to whether 60 minutes has passed after the last access to the mail server 60.

If it is judged that the time passed is 60 or more, the control goes to Step S305, to give an instruction to the communication unit 401 to access the mail server 60.

At Step S302, if it is judged that 60 minutes has not passed, the control goes to Step S303 to judge whether it is when a print operation has ended (Step S303).

Here, ending of a print operation means that a print operation for all the jobs that have been received is ended.

Every time the main control unit 403 receives a print job from an external terminal via the communication unit 401, and/or every time a series of original is scanned to perform a copy job, the main control unit 403 stores the image data in the image storage unit 408, and assigns a job number to the print job or to the copy job, in the receiving order, and registers the print job or the copy job in the job management table together with the corresponding page number and soon, the job management table being created in the internal memory of the main control unit 403, and not shown in the drawings. Job management is performed by deleting a registration after the corresponding job is completed. When all the job registrations have been deleted by the print operation, a flag that represents the ending of the print operation is set in the internal memory. At Step S303, the state of this flag is referred to for knowing whether it is when the print operation has ended. Note that this flag is, for example, reset after judged “YES” in the next step S304.

If, at Step S303, judgment is made that it is when the print operation has ended, it is then judged as to whether a second time period (15 minutes) has passed after the last access to the mail server 60 (Step S304), and only if judged to have passed 15 minutes, access to the mail server 60 is permitted (Step S304:YES, Step S305).

The purpose of setting such time limit is to prohibit more than necessary number of accesses to occur to the mail server 60, just as in the first embodiment. However, it is usual that the print operation for i-FAX data ends in a short time, and so another access will follow immediately if without a time limit. Therefore, the time limit is more meaningful in the second embodiment.

In the second embodiment, too, it is needless to say that the time limit (second time period) is preferably shorter than await time before the power-saving mode is activated (third time period).

At Step S306, if judged that there is new i-FAX data addressed to the MFP40 itself, the i-FAX data is obtained from the mail server 60 (Step S307), the encoded image data is decoded (Step S308), and a print operation is performed at the printer unit 430 according to the decoded image data (Step S309).

As described above, the operations of Steps S302-S309 are repeatedly performed, until the main power source of the MFP40 is turned off.

As described above, the present embodiment is structured to access the mail server when a print operation is ended. Therefore, if i-FAX addressed to the MFP40 is received at this time, it is not necessary to interrupt the power-saving mode, only for outputting the i-FAX, because the power-saving mode has been deactivated by then.

In addition, by performing access each time a print operation ends as described above, even if a regular access to the mail server 60, which is to be performed when the first time period has passed, is performed during the power-saving mode, the probability is lessened that the mail server 60 stores i-FAX addressed to the MFP40 during that time period. This accordingly lessens the probability of deactivating the power-saving mode for the purpose of outputting i-FAX, which contributes to the power-saving.

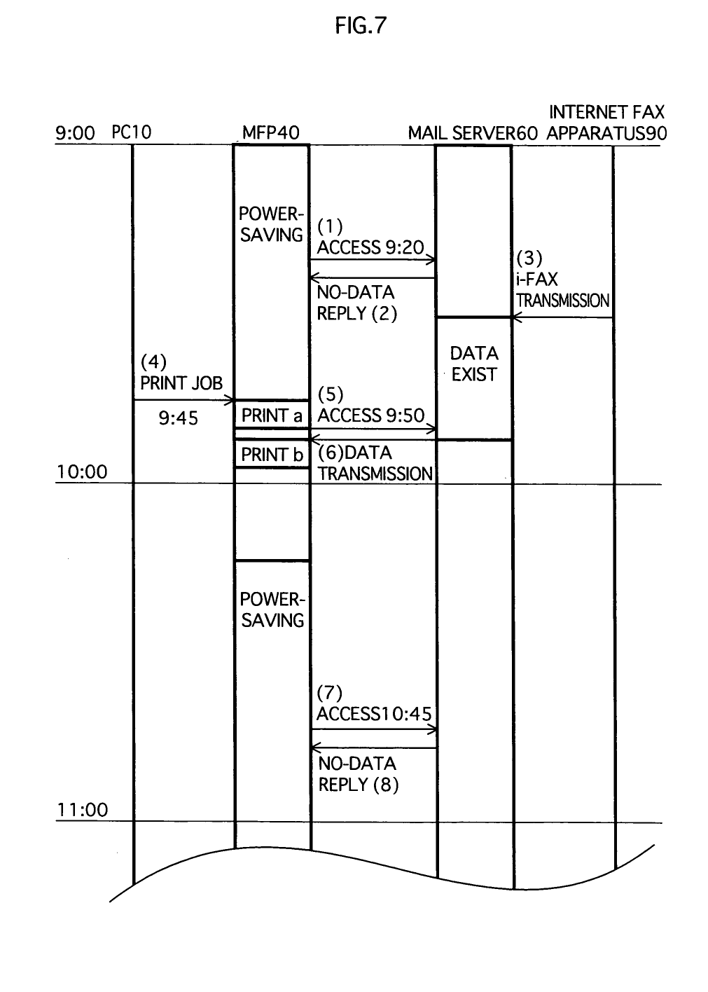

FIG. 7 shows one example of the time chart for the i-FAX data receiving operation, together with the communication sequence with other devices, in the second embodiment.

The MFP40 is, for example at 9:00 AM, in the power-saving mode. When a regular access time has arrived at the time 9:20, and access ((1)) is made to the mail server 60, the mail server 60 has not yet received any i-FAX addressed to the MFP40, therefore transmits a reply reporting as such to the MFP40 ((2)). At this stage, there is no data to be printed out, therefore the power-saving mode will continue without interruption. At the time 9:45, when receiving a print job from the PC10 ((4))), the MFP40 deactivates the power-saving mode, and starts operation for the print job (print a).

When the print a is completed, the MFP40 accesses the mail server 60 ((5)). By this time, the i-FAX data addressed to the MFP40 has received from the i-FAX apparatus 70 ((3)), therefore the MFP40 receives the data transmission from the mail server 60 ((6)), and performs a print operation (print b) according to the received i-FAX data, following the aforementioned print job.

At the time when the print b ends, 15 minutes has not passed after the last access time (5), therefore access to the mail server 60 is not performed (refer to FIG. 6, Step S304). Instead, the power-saving mode is activated after a third time period has passed (20 minutes). During the power-saving mode, at the time 10:50 when 60 minutes has passed after the access of (5), access (7) to the mail server 60 is made. However, since acquisition of i-FAX is already done at the stage of (5), there is not new data in the mail serve 60, and so a “no-data” reply is returned ((8)). Accordingly, the power-saving mode is not deactivated.

As described above, the present embodiment also prevents the decrease in power saving effect as possible, which would be attributable to a print operation of i-FAX during the power-saving mode.

### MODIFICATION EXAMPLE

So far, the present invention has been described by way of the embodiments. However, needless to say, the content of the present invention should not be limited to the concrete examples shown as the described embodiments, and the following modification examples are possible.

(1) In each of the embodiments stated above, the first, second, and third time periods are set as 60, 15, and 20 minutes, respectively. However needless to say, these time periods are not limited to such. It is also possible to make an arrangement that a user can modify such time periods, using the operation panel 411 or the PC70, according to each use environment.

For example, when the i-FAX reception frequency is comparatively high, the first and second time periods may be set to be shorter. In addition, if the computer use frequency is low, then the third time period may be set to be shorter.

As mentioned above, however, it is still desirable that the second time period is shorter than the third time period. In addition, if the second time period becomes longer than the first time period, no access will be performed at all, and so such modification should not be permitted.

(2) In the embodiments stated above, the timings of access to the mail server 60 are respectively set as “when the power-saving mode gets deactivated (first embodiment)”, and “when a print operation ends (second embodiment)”. However, an arrangement may be made to access the mail server 60, at both of the timings. The power-saving effect decreases due to interruption of the power-saving mode caused by receiving i-FAX data during the power-saving mode. In view of this, another timing may be utilized to access the mail server, as long as it is when the power-saving mode is not activated. One example of the other timing is when a fourth time period has passed after the ending of a print operation where the fourth time period is shorter than the third time period (e.g. 5 minutes) In such a case too, the power-saving effect will improve compared to the conventional technology.

(3) In the embodiments stated above, access to the mail server 60 is performed “when the power-saving mode gets deactivated (first embodiment)” and “when a print operation ends (Second embodiment)”, and a regular access is made when the first time period (60 minutes) has passed thereafter. However, the regular access is not always compulsory.

In particular, according to the second embodiment, if it is not within a predetermined time limit from the last access, the access will be inevitably performed. Therefore under a use environment where print jobs are frequently issued, there is not so much necessity to perform such regular access in addition to at the ending of a print operation.

(4) It should be noted that the programs relating to the i-FAX data transmission/reception, which are used in the embodiments stated above, may be recorded on various types of computer-readable recording media. The recording media include magnetic tape, a magnetic disk such as a flexible disk, optical recording media that include a DVD, a CD-ROM, a CD-R, an MO, and a PD, and flash memory-type recording media such as Smart Media (registered trademark), and COMPACTFLASH (registered trademark). Sometimes the programs are produced and transferred in the form of such recording media. Alternatively, the programs themselves may be conveyed or supplied via various networks either wired such as the Internet, or wireless, and via broadcast, electric communication circuits, and satellite communications, and so on.

In addition, it is not an essential feature that the programs for realizing the present invention include all the modules for making the computer execute the described operations. It is alternatively possible to execute each of the operations on a computer, with use of various general-purpose programs installable to an information processing apparatus. The examples of the general-purpose programs are communication programs and programs that the operation systems (OS) include.

(5) In the embodiments stated above, an MFP is used as one example of the image forming apparatus to which the present invention is applied. However, the image forming apparatus of the present invention is not limited to such an MFP, and may be a printer, a facsimile apparatus, and any other type of image forming apparatuses, as long as it is equipped with an i-FAX function.

(6) In the embodiments stated above, image data transmission/reception by means of i-FAX is performed using the existing electronic mail system. However, the present invention is applicable to an image forming system as long as the system includes an external apparatus operable to store image data in association with an identifier assigned to a device, and a particular device downloads image data associated with the identifier of the device itself, for forming an image.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

1. An image forming apparatus for transmitting and receiving data to/from an external apparatus, the image forming apparatus comprising:
a communication unit that accesses the external apparatus, and when the external apparatus stores image data addressed to the image forming apparatus, obtains the image data;
an image forming unit that performs an image forming operation according to the obtained image data;
a power-saving control unit that controls a power-saving mode to be activated or deactivated; and
a communication control unit that controls the communication unit to make an access to the external apparatus while the power-saving mode is deactivated.

2. The image forming apparatus of claim 1, wherein
the access is made when the power-saving mode gets deactivated.

3. The image forming apparatus of claim 1, wherein
the access is made when an image forming operation ends.

4. The image forming apparatus of claim 1, wherein
the communication control unit further controls the communication unit to make another access to the external apparatus when a first time period has passed after a last access to the external apparatus.

5. The image forming apparatus of claim 1, further comprising:
a prohibition unit that prohibits the communication unit from accessing the external apparatus, until a second time period has passed after a last access to the external apparatus.

6. The image forming apparatus of claim 5, wherein
the power-saving control unit activates the power-saving mode when no image forming operation is performed for a third time period, and the second time period is shorter than the third time period.

7. The image forming apparatus of claim 6, wherein
the external apparatus functions as an electronic mail server, and the image data that the communication unit obtains from the external apparatus is image data attached to electronic mail.

8. An image forming system comprising: a server for storing image data; and an image forming apparatus for transmitting and receiving data to/from the server via a network, wherein
the server includes:
a storage unit that stores image data in correspondence with a network address; and
a transmission unit that, in response to a request by an external terminal, transmits image data that corresponds to a network address of the external terminal, and
the image forming apparatus includes:
a request unit that accesses the server and requests, from the server, image data addressed to the image forming apparatus;
a reception unit that receives the image data transmitted from the server;
an image forming unit that performs an image forming operation according to the received image data;
a power-saving control unit that controls a power-saving mode to be activated or deactivated; and
a request control unit that controls the request unit to access the server while the power-saving mode is deactivated.

9. An image forming method executed in an image forming apparatus, the image forming apparatus having a power-saving unit that controls a power-saving mode to be activated or deactivated, and being for transmitting and receiving data to/from an external apparatus, the image forming method comprising:
an image-data obtaining step of making an access to the external apparatus while the power-saving mode is deactivated, and of, when the external apparatus stores image data addressed to the image forming apparatus, obtaining the image data; and
an image forming step of performing an image forming operation according to the obtained image data.

10. The image forming method of claim 9, wherein
the access is made when the power-saving mode gets deactivated.

11. The image forming method of claim 9, wherein
the access is made when an image forming operation ends.

12. The image forming method of claim 9, wherein
in the image-data obtaining step, another access to the external apparatus is performed when a first time period has passed after a last access to the external apparatus.

13. The image forming method of claim 9, wherein
the image-data obtaining step includes an access prohibition substep of prohibiting an access to the external apparatus, until a second time period has passed after a last access to the external apparatus.

14. The image forming method of claim 13, wherein
the power-saving control unit activates the power-saving mode when no image forming operation is performed for a third time period, and the second time period is shorter than the third time period.

15. The image forming method of claim 9, wherein
the external apparatus functions as an electronic mail server, and the image data obtained at the image-data obtaining step from the external apparatus is image data attached to electronic mail.

16. A program executed in an image forming apparatus, the image forming apparatus having a power-saving unit that controls a power-saving mode to be activated or deactivated, and being for transmitting and receiving data to/from an external apparatus, the program making the image forming apparatus perform:
an image-data obtaining operation of accessing the external apparatus while the power-saving mode is deactivated, and of, when the external apparatus stores image data addressed to the image forming apparatus, obtaining the image data; and
an image forming operation of performing an image forming operation according to the obtained image data.

17. A computer-readable recording medium that stores therein a program executed in an image forming apparatus, the image forming apparatus having a power-saving unit that controls a power-saving mode to be activated or deactivated, and being for transmitting and receiving data to/from an external apparatus, the program making the image forming apparatus perform:
an image-data obtaining operation of accessing the external apparatus while the power-saving mode is deactivated, and of, when the external apparatus stores image data addressed to the image forming apparatus, obtaining the image data; and
an image forming operation of performing an image forming operation according to the obtained image data.
